(19) United States
(12) Patent Application Publication
(10) Pub. No.: US 2014/0189393 A1
(43) Pub. Date: Jul. 3, 2014

(54) POWER SUPPLY AND METHOD FOR SUPPLYING POWER TO MOTHERBOARD

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: YONG-CHANG FAN, Wuhan (CN); SAN-YONG YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/968,569

(22) Filed: Aug. 16, 2013

(30) Foreign Application Priority Data
Dec. 27, 2012 (CN) 2012105776397

(51) Int. Cl. G06F 1/32

(52) U.S. Cl. CPC G06F 1/3296
USPC 713/320

(57) ABSTRACT

A monitored and high-efficiency power supply for a motherboard includes an AC-to-DC conversion circuit, a control circuit, a standby circuit, a main output circuit, a standby output circuit. The AC-to-DC conversion circuit converts an AC source voltage to a DC voltage. When the power supply is in a standby state, the standby circuit is enabled but when the power supply is in a normal working state, the standby circuit is disabled, and the control circuit is enabled to control only the main voltage output to the motherboard. A method for supplying power to a motherboard is also provided.

### REFERENCE TO RELATED APPLICATIONS

This application claims all benefits accruing under 35 U.S.C. §119 from China Patent Application No. 201210577639.7, filed on Dec. 27, 2012 in the State Intellectual Property Office of China. The contents of the China Application are hereby incorporated by reference.

### BACKGROUND

1. Technical Field

The disclosure generally relates to power supplies, and particularly relates to power supplies and methods for supplying power to a motherboard.

2. Description of Related Art

A motherboard is the main printed circuit board (PCB) found in a computer. The motherboard holds many of the crucial electronic components of a computer, such as a central processing unit (CPU) and a memory. A power supply is designed for supplying power to the motherboard. However, the energy performance of the power supply may not be applied efficiently or capable of saving excess power.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a power supply for supplying power to a motherboard.

FIG. 2 is a block diagram of one embodiment of a switching circuit for switching between a power output from a standby output circuit and a power output from a main output circuit.

FIG. 3 is a flowchart of one embodiment of a method for supplying power to a motherboard.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

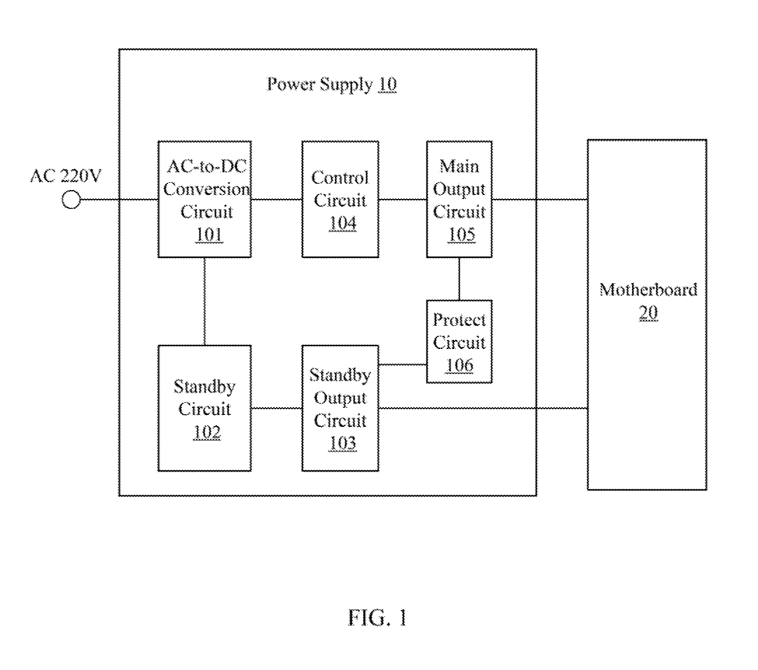

FIG. 1 shows one embodiment of a power supply 10 for supplying power to a motherboard 20. The power supply 10 includes an AC-to-DC conversion circuit 101, a standby circuit 102, a standby output circuit 103, a control circuit 104, a main output circuit 105, and a protect circuit 106.

The AC-to-DC conversion circuit 101 is connected to an AC source voltage. The AC-to-DC conversion circuit 101 converts the AC source voltage to one or more DC voltages. For example, the AC-to-DC conversion circuit 101 can convert an AC 220V voltage to a DC 12V voltage.

An input terminal of the standby circuit 102 is connected to the AC-to-DC conversion circuit 101 and an output terminal of the standby circuit 102 is connected to the standby output circuit 103.

An input terminal of the control circuit 104 is connected to the AC-to-DC conversion circuit 101 and an output terminal of the control circuit 104 is connected to the main output circuit 105.

A first input terminal of the protect circuit 106 is connected to standby output circuit 103 and a second input terminal of the protect circuit 106 is connected to the main output circuit 105. The protect circuit 106 monitors the voltage output from the standby output circuit 103 and the main output circuit 105. If the voltage output from the standby output circuit 103 or from the main output circuit 105 exceeds a safe voltage, the protect circuit 106 cuts off the overproducing standby output circuit 103 or the overproducing main output circuit 105.

When the power supply 10 is in a standby state, the standby circuit 102 is enabled and the control circuit 104 is disabled. The standby circuit 102 controls the standby output circuit 103 to output a standby DC voltage to the protect circuit 106 and the motherboard 20.

When the power supply 10 is in a normal working state, the standby circuit 102 is disabled and the control circuit 104 is enabled. The control circuit 104 controls the main output circuit 105 to output a main DC voltage to the motherboard 20 and the protect circuit 106.

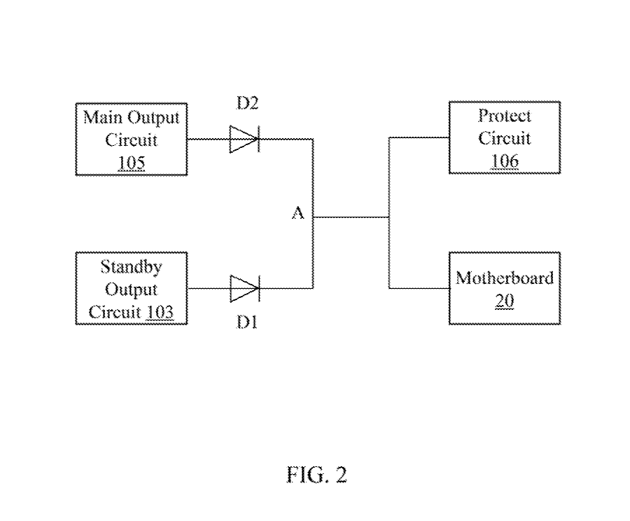

FIG. 2 shows a switching circuit for switching between a power output from the standby output circuit 103 and a power output from the main output circuit 105. The standby output circuit 103, the main output circuit 105, the protect circuit 106, and the motherboard 20 are all connected to a node A. The standby output circuit 103 is connected to the node A via a diode D1. The main output circuit 105 is connected to the node A via a diode D2. The positive terminal of the diode D1 is connected to the standby output circuit 103 and the negative terminal of the diode D1 is connected to the node A. The positive terminal of the diode D2 is connected to the main output circuit 105 and the negative terminal of the diode D2 is connected to the node A.

When the standby output circuit 103 outputs a standby DC voltage and the main output circuit 105 does not output a main DC voltage, the diode D1 is turned on and the diode D2 is turned off. The turned-on diode D1 allows the standby output circuit 103 to output the standby DC voltage to the protect circuit 106 and the motherboard 20. The turned-off diode D2 prevents the standby output circuit 103 from outputting the standby DC voltage to the main output circuit 105.

When the standby output circuit 103 outputs the standby DC voltage and the main output circuit 105 outputs the main DC voltage, the diode D1 is turned off and the diode D2 is turned on since the main DC voltage is higher than the standby DC voltage.

The turned-on diode D2 allows the main output circuit 105 to output a main DC voltage to the protect circuit 106 and the motherboard 20. The turned-off diode D1 prevents the standby output circuit 103 from outputting a standby DC voltage to the protect circuit 106 and the motherboard 20.

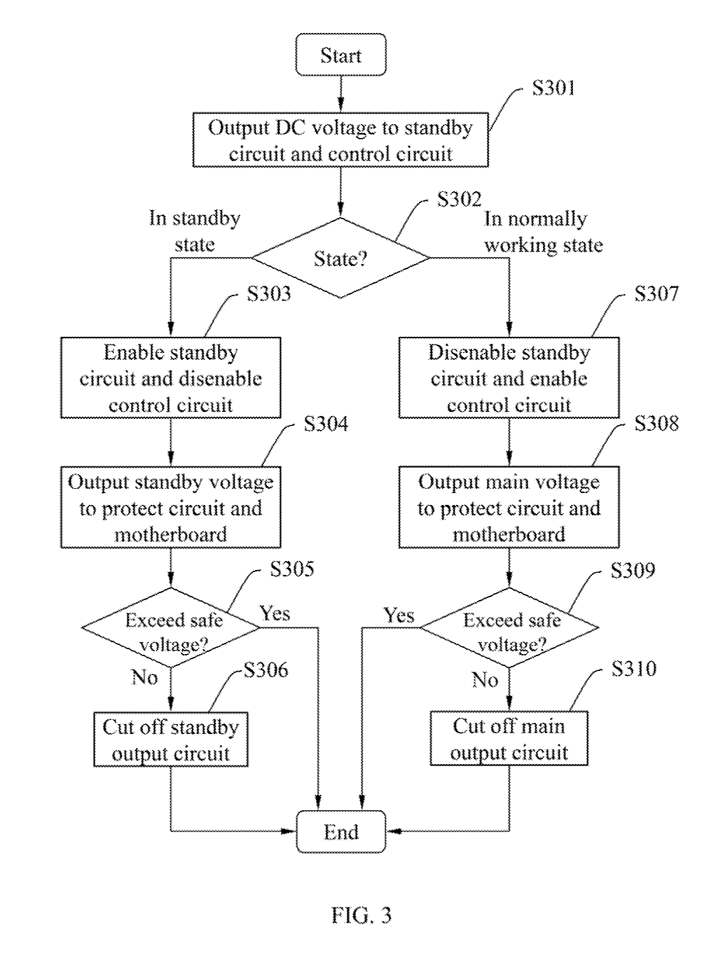

FIG. 3 shows a flowchart of one embodiment of a method for supplying power to the motherboard 20. The method includes the following steps.

In step S301, the AC-to-DC conversion circuit 101 converts an AC source voltage to one or more DC voltages and outputs a DC voltage to the standby circuit 102 and to the control circuit 104.

In step S302, the power supply 10 determines a state of the power supply 10. If the power supply 10 is in a standby state, the flow proceeds to step S303. If the power supply 10 is in a normal working state, the flow proceeds to step S307.

In step S303, the standby circuit 102 is enabled and the control circuit 104 is disabled.

In step S304, the standby circuit 102 controls the standby output circuit 103 to output a standby DC voltage to the protect circuit 106 and the motherboard 20.

In step S305, the protect circuit 106 monitors the standby DC voltage output from the standby output circuit 103. If the standby DC voltage exceeds a safe voltage, the flow proceeds to step S306.

In step S306, the protect circuit 106 cuts off the standby output circuit 103.

In step S307, the standby circuit 102 is disabled and the control circuit 104 is enabled.

In step S308, the control circuit 104 controls the main output circuit 105 to output a main DC voltage to the motherboard 20 and the protect circuit 106.

In step S309, the protect circuit 106 monitors the main DC voltage output from the main output circuit 105. If the main DC voltage exceeds a safe voltage, the flow proceeds to step S310.

In step S310, the protect circuit 106 cuts off the main output circuit 105.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered.

The description and the claims drawn for or in relation to a method may give some indication in reference to certain steps. However, any indication given is only to be viewed for identification purposes, and is not necessarily a suggestion as to an order for the steps.

What is claimed is:

1. A power supply for supplying power to a motherboard, the power supply comprising:
an AC-to-DC conversion circuit for converting an AC source voltage to one or more DC voltages;
a control circuit connected to the AC-to-DC conversion circuit;
a standby circuit connected to the AC-to-DC conversion circuit;
a main output circuit connected to the control circuit; and
a standby output circuit connected to the standby circuit and the control circuit;
wherein when the power supply is in a standby state, the standby circuit is enabled, the control circuit is disabled, and the standby circuit controls the standby output circuit to output a standby voltage to the motherboard, when the power supply is in a normal working state, the standby circuit is disabled, the control circuit is enabled, the control circuit controls the main output circuit to output a main voltage to the motherboard.

2. The power supply of claim 1, wherein the main output circuit and the standby output circuit are connected to a joint node, the main output circuit is configured to output the main voltage to the motherboard via the joint node, and the standby output circuit is configured to output the standby voltage to the motherboard via the joint node.

3. The power supply of claim 2, wherein the standby output circuit is connected to the joint node via a first diode, and the main output circuit is connected to the joint node via a second diode.

4. The power supply of claim 3, wherein a positive terminal of the first diode is connected to the standby output circuit and a negative terminal of the first diode is connected to the joint node.

5. The power supply of claim 3, wherein a positive terminal of the second diode is connected to the main output circuit and a negative terminal of the second diode is connected to the joint node.

6. The power supply of claim 1, further comprising a protect circuit connected to the standby output circuit and the main output circuit, wherein the protect circuit is configured to monitor the standby voltage output from the standby output circuit and the main voltage output from the main output circuit.

7. The power supply of claim 6, wherein when the standby voltage output from the standby output circuit exceeds a safe voltage, the protect circuit is configured to cut off the standby output circuit.

8. The power supply of claim 6, wherein when the main voltage output from the main output circuit exceeds a safe voltage, the protect circuit is configured to cut off the main output circuit.

9. The power supply of claim 6, wherein when the power supply is in the standby state, the standby circuit controls the standby output circuit to output the standby voltage to the protect circuit, when the power supply is in the normal working state, the control circuit controls the main output circuit to output the main voltage to the protect circuit.

10. A method for supplying power to a motherboard, the method comprising:
providing a power supply comprising an AC-to-DC conversion circuit, a control circuit, a standby circuit, a main output circuit, and a standby output circuit;
converting an AC source voltage to one or more DC voltages by the AC-to-DC conversion circuit;
outputting the DC voltage to the control circuit and a standby circuit by the AC-to-DC conversion circuit;
when the power supply is in a standby state, enabling the standby circuit and disabling the control circuit, and controlling, by the standby circuit, the standby output circuit to output a standby voltage to the motherboard; and
when the power supply is in a normal working state, disabling the standby circuit and enabling the control circuit, and controlling, by the control circuit, the main output circuit to output a main voltage to the motherboard.

11. The method of claim 10, further comprising connecting the main output circuit and the standby output circuit to a joint node, wherein the main output circuit outputs the main voltage to the motherboard via the joint node, and the standby output circuit outputs the standby voltage to the motherboard via the joint node.

12. The method of claim 11, wherein the standby output circuit is connected to the joint node via a first diode, and the main output circuit is connected to the joint node via a second diode.

13. The method of claim 12, wherein a positive terminal of the first diode is connected to the standby output circuit and a negative terminal of the first diode is connected to the joint node.

14. The method of claim 12, wherein a positive terminal of the second diode is connected to the main output circuit and a negative terminal of the second diode is connected to the joint node.

15. The method of claim 10, further comprising:
connecting a protect circuit to the standby output circuit and the main output circuit; and
monitoring the standby voltage output from the standby output circuit and the main voltage output from the main output circuit by the protect circuit.

16. The method of claim 15, further comprising cutting off the standby output circuit by the protect circuit when the standby voltage output from the standby output circuit exceeds a safe voltage.

17. The method of claim 15, further comprising cutting off the main output circuit by the protect circuit when the main voltage output from the main output circuit exceeds a safe voltage.

18. The method of claim 15, further comprising:
when the power supply is in the standby state, controlling, by the standby circuit, the standby output circuit to output the standby voltage to the protect circuit;
when the power supply is in the normal working state, controlling, by the control circuit, the main output circuit to output the main voltage to the protect circuit.
